(19) United States
(12) Patent Application Publication
(10) Pub. No.: US 2011/0061588 A1
(43) Pub. Date: Mar. 17, 2011

(54) Device for Colouring Microscope Slides

(76) Inventor: Alain Truchaud, Nantes (FR)

(21) Appl. No.: 12/993,804

(22) PCT Filed: May 18, 2009
(86) PCT No.: PCT/FR09/50920

§ 371 Date: Nov. 19, 2010

(30) Foreign Application Priority Data
May 19, 2008 (FR) 08 53216

(51) Int. Cl. B05C 13/00

(52) U.S. Cl. 118/52

(57) ABSTRACT

The subject of the invention is a device for coloring microscope slides L, comprising a base that includes motor means, and is surrounded by an enclosure (14) closed off by a cover (16), said base being capable of accommodating said slides L and of being rotated by said motor means, characterized in that it includes a removable casing (40) placed inside the enclosure (14).

The present invention relates to a device for coloring microscope slides.

Several devices are known for coloring slides for microscopic examination.

In one known device, colorants are pulverized on the slides carrying the sample to be examined. This type of technique requires micronized pulverization.

Another technique consists in coloring through capillary action between a plate and each slide put in contact with said plate.

There is also a so-called flow technique which consists in letting the coloring composition flow on the slide, which is slow and incompatible with the needs of an analysis laboratory so that this technique remains reserved for research. In addition, during the flow, the chamber is contaminated by the flowing composition.

An interesting solution which is employed in numerous automated processes consists in soaking slides in baths with appropriate intermediate flushing and drying.

Up to 8% to 10% of the preceding bath composition can be left over when soaking in the following bath, which leads to rapid quality degradation of said bath.

The solution for attaining constant and optimal quantity is to soak in unitary micro bath filled with reacting colorant, with flushing liquid, then emptied after each use. It does not avoid a certain contamination when passing from one bath to another, but there is no accumulated pollution because each micro bath is discarded after single use.

The necessary containers are very specific therefore the process implies slide by slide treatment. It is not possible to process a slide lot.

The goal of the present invention is to propose a device that ensures the quality of the treatment in unitary micro bath, but with the possibility of treating lots in order to achieve a sufficient cadence.

This type of device meets the expectations of small medical analysis laboratories and health organizations of developing countries that are poorly equipped, or extenuates the temporary overload of the treatment capabilities of organizations equipped with automated equipment, or ensures a very temporary replacement in case, for instance, of intervention or maintenance on this automated equipment.

This sought after device, suitable to meet this specific need, must also require extremely low maintenance, have very low operating cost, high reliability and low purchase price to make it accessible in large numbers.

The sought after device must also be open, in other words usable with appropriate reactants but not dedicated or controlled by said device.

The device according to the present invention is now described based on the attached drawings, according to a schematic implementation mode given exclusively as an example. These drawings contain the following figures, representing:

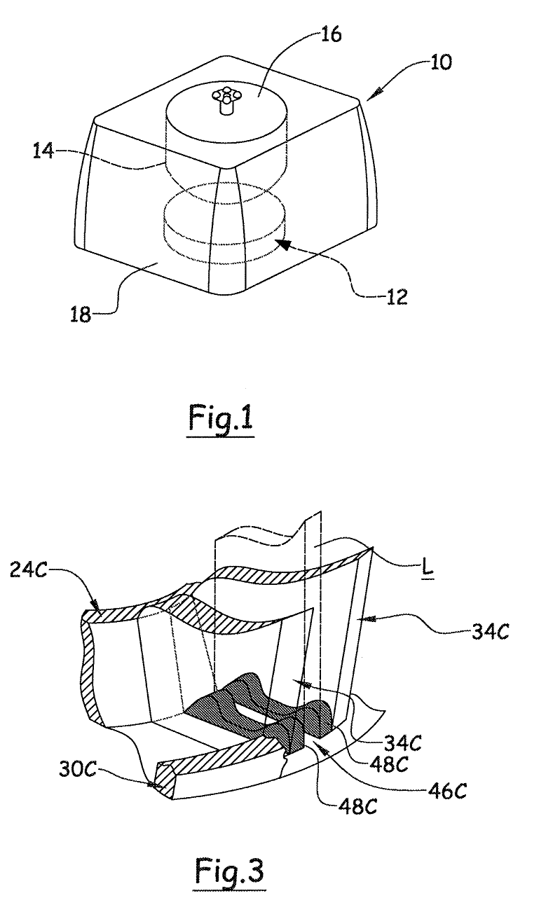

FIG. 1: a schematic view in perspective of the device,

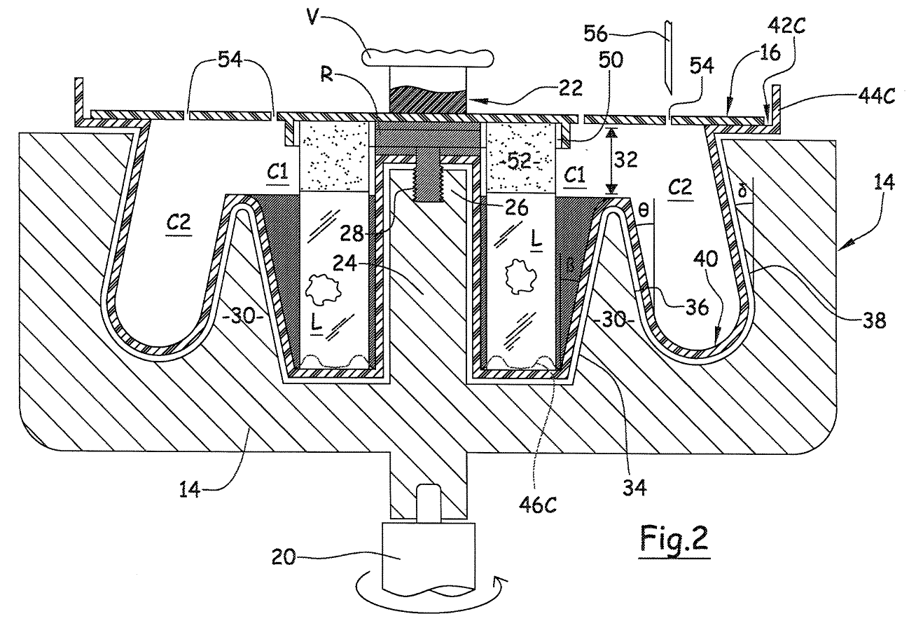

FIG. 2: a sectional view of the device,

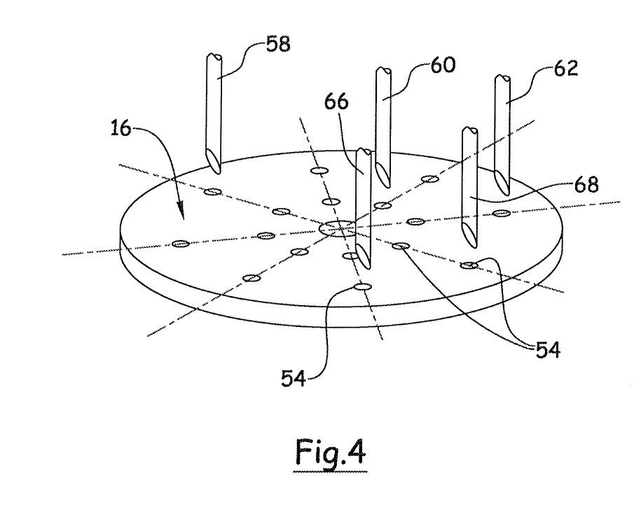

FIG. 3: a detail view of a method for holding the slides,

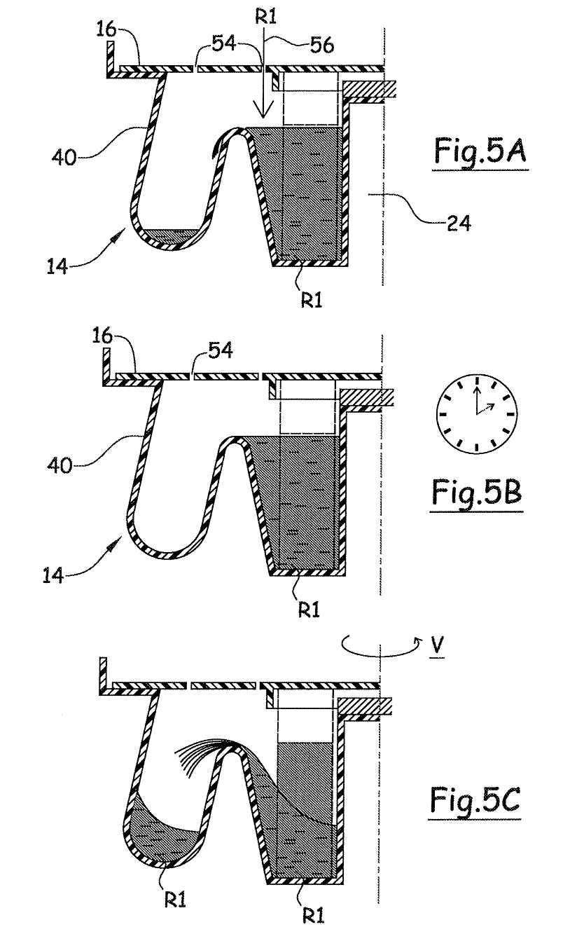

FIG. 4: a schematic view from above of a casing according to the present invention,

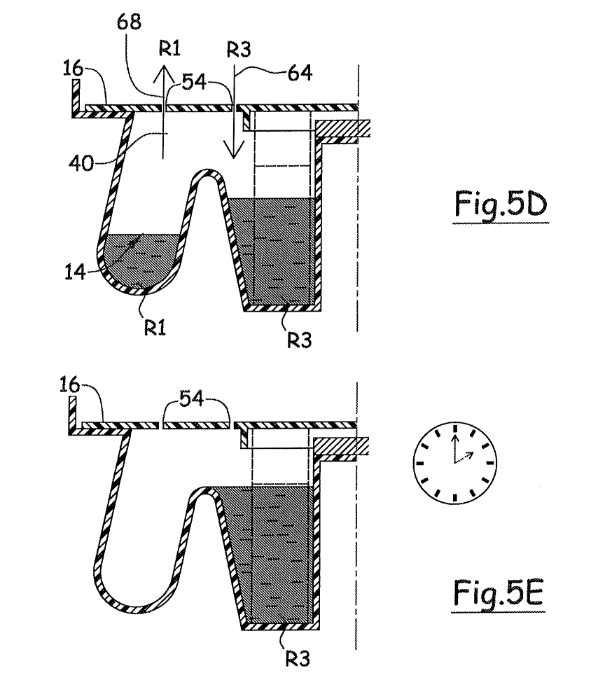

FIGS. 5A to 5E: synoptic views of the operation,

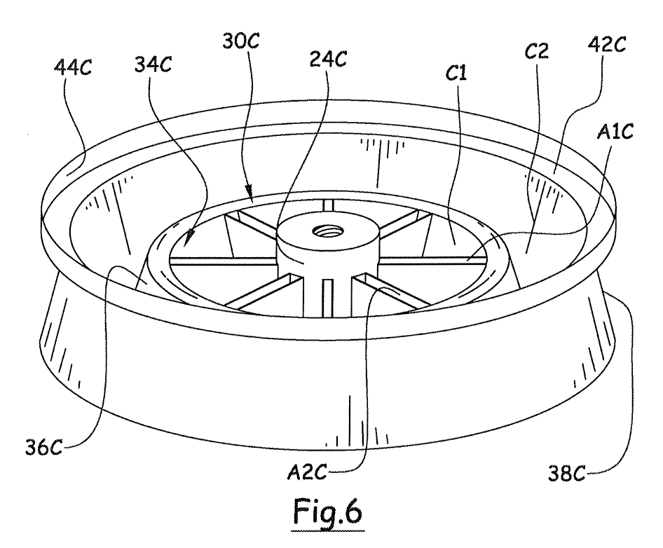

FIG. 6: a view in perspective of the casing according to the present invention.

FIG. 1 shows the device for coloring slides L according to the invention.

The motor means 12 are advantageously of the type comprising a motor 18 with shaft 20 driving enclosure 14. Motor 18 is an incremental displacement step motor but is also suitable to provide rotation at relatively high speed in the order of magnitude of several hundreds of revolutions per minute.

Enclosure 14 is shown in detail in FIG. 2. This enclosure is cylindrical and comprises removable means 22 for fastening cover 16. These removable fastening means for cover 16 consist of a central shaft 24 with extremity 26 provided with a thread 28 intended to receive a fastening screw V. Advantageously, the hand of the thread is reversed relative to the direction of rotation in order to avoid untimely unscrewing. A washer R takes up the clamping force and positions the slides as will be explained below.

At the periphery of this shaft 24, an annular relief 30 defines a first chamber C1 called the slides processing chamber and a second chamber C2 called the process reactant receiving chamber; these two chambers are concentric.

Characteristic for this annular relief is that its height is smaller than the distance between the bottom of the enclosure and the cover, leaving a passage 32.

Throughout the rest of the description, the designations interior and exterior indicate directions from the center towards the periphery of the device.

The interior wall 34 of this relief, on the side of the first chamber C1, has a mild slope with angle β relative to the vertical, for instance 15°. In more advanced manner, the interior peripheral angle of this relief 30 has a mildly rounded fillet, in other words with a large radius.

The exterior wall 36 of relief 30, on the side of the second chamber C2, is also inclined, with angle θ, selected with value smaller than angle β, near the vertical, for instance 10°.

The peripheral angle between relief 30 and said wall 36 has a rounded fillet but with a tight fillet, with small radius.

This first chamber comprises cavities A1 to An, in this case A1 to A8, equally spaced angularly. These cavities are defined by identical radial walls. As an example, each cavity has a very small volume of a few ml.

Chamber C2 is delimited by the exterior wall 36 of relief 30 and by an interior peripheral wall 38. This chamber does not have cavities. The exterior peripheral wall 38 is inclined towards the interior with negative angle δ, approximately identical to angle θ, so that interior wall 36 and exterior wall 38, defining the second chamber C2, are approximately parallel. The height of interior wall 38 is equal to the height of shaft 24 with washer R mounted on top so that cover 16 locates on washer R which is supported by shaft 24 and on the periphery of enclosure 14.

The device according to the invention has a monolithic, removable and single use, casing that conforms to the profile of enclosure 14, with a central hole through which passes the body of the screw V.

This casing is advantageously made starting from an impervious material such as thermoplastic polymer or biodegradable material, of very small thickness, thermoformed and with conjugate profile to the interior part of the enclosure, with allowance for manufacturing tolerances and mechanical construction constraints.

The parts of the casing corresponding to the parts of the enclosure are referenced with the same numbers, to which is associated a suffix C.

To be noted that during fabrication, wall 38C is thermoformed with a positive angle because all negative draft angles must be avoided in order not to prevent the retraction from the thermoforming mould of the casings produced in this way in. Nevertheless, when put in place, this wall 38C of casing 40 can be lightly deformed towards the interior so that it adheres to the profile of the enclosure and flattens itself against wall 38.

In an advanced version this casing has a balcony 42C, also moulded and intended to locate on the periphery of the enclosure.

A peripheral edge 44C ensures the centering of the cover as will be shown below in the description of the operation.

Casing 40 comprises in identical manner cavities A1C, A2C . . . A8C. Casing 40 contributes also to the holding of slides L by their small lower side thanks to imprints 46C, which by preference are also thermoformed.

FIG. 3 shows also in these imprints 46C the presence of protruding ribs 48C, which are radially oriented in order to hold said slides with their inferior angles, inside each cavity, and to limit surface contact with each slide. In this way, each slide L is colored over the majority of its surface and the central examination zone is perfectly colored, without any obstacles. Cover 16 is special because it performs several functions, specifically protection against possible contamination from the outside and against risk of projection when motions are started. Cover 16 ensures also mechanical holding of slides L because it is provided with cavities 50 intended to receive the small upper end of each slide. Each cavity 50 can be deeper because the slides are held in the slide marking zone 52, which in general is sintered glass, a zone which is not examined and not colored.

Each slide is immobilized radially and tangentially by means of its two, upper and lower, small sides in cavity A1 . . . A8 in which it is placed. The cover comprises also through holes 54, suitable for insertion of injection/removal cannula 56. These holes are arranged so as to allow at least access to each chamber C1 and C2 and access to each cavity A1 . . . A8 of chamber C1, on the right of each slide L.

The injection/removal cannulae are distributed successively to perform the different operations.

FIG. 4 shows that it is possible to reach through the different holes to the two chambers C1 and C2, in particular to inject reactants in the cavities of chamber C1 through injection cannulae 58, 60 and 62, to inject hot air for drying through cannula 64, to inject a washing composition through cannula 66 and to aspirate the used reactants from chamber C2 through cannula 68.

The operation of the device according to the present invention is now described in detail, more particularly relative to FIGS. 5A and 5E.

The operator has slides L to be colored. To make the device operational he places a new casing 40 in the open enclosure. Once the housing is in place, according to the needs, the operator places one or several slides in this casing, in function of the capacity of the device and the requirements. Each slide carrying the sample to be colored is prepositioned with its lower end between ribs 48. Once the slides are in place, the operator installs cover 16 with washer R and screw V. This action ensures that the slides are immobilized. The device is then ready and the step motor is commanded, either manually or through simple automation, to present one hole 54 in front of cannula 58, 60 or 62, to provide access to cavity A1 of chamber C1 and to perform the injection of reactant, for instance RE in FIG. 5A.

To be noted that the distribution of reactants is often provided by peristaltic pumps of which is known that the flow is not very precise. This is a problem especially when the desire is to have quick filling, therefore requiring a large section, and at the same time a precisely distributed volume.

To resolve these antagonistic constraints, in the case of the present device it is sufficient to provide a slightly excessive volume distribution, since in all cases the surplus of reactant is evacuated above the relief 30, from cavity A1 of chamber C1 towards chamber C2, see FIG. 5A. Each slide L is soaked in its micro bath of reactant during the necessary time for coloration, which is linked to the type of reactant, see FIG. 5B.

Immediately after, motor 18 of motor means 12 is started to generate a rotation at high speed V of around 100 revolutions per minute in order to provoke the displacement of the reactant in each cavity A1 . . . A8 from chamber C1 to chamber C2, under the influence of the centrifugal force, FIG. 5C.

The slope with angle β facilitates the passage, forming an evacuation slope and the suitably rounded fillets ensure that the flow thread does not detach from the relief in the upper part and flows directly towards the bottom of chamber C2. A person skilled in the art will adapt speed, slopes and fillets to obtain this result in function of the retained architecture, the used materials with their wettability coefficient and the dimensions, without any inventive effort but strictly starting from known calculations and/or current tests.

The time is very short because the reactant R1 is evacuated rapidly, especially since the quantity is very small.

To be noted that the slides arranged with their surface oriented radially offer no resistance to the flow.

Similarly, the reactant adhering by capillarity to each blade is also evacuated by the tangential centrifugal force. This occurs rapidly also because the micro drops traverse the slide only over the width.

The quantity of reactant remaining in each cavity A1 . . . A8 of C1 is totally negligible.

The used reactant R1 is now transferred in chamber C2. To be noted that during the rotation, the negative draft angle δ of the exterior wall of this chamber C2 and its height have prevented any projection of transferred reactant outside this chamber C2, which has a much greater volume than the accumulated unitary volumes of the cavities.

In function of the needs, the operator commands on the one hand the aspiration of reactant R1 from chamber C2 through cannula 68 and on the other hand the injection, for instance, of reactant R3 in cavities A1 . . . A8 of chamber C1. These two operations, although very fast, can be performed in masked time.

The slides are submitted to the coloration time, FIG. 5B and the cycle continues.

According to the needs, a flushing phase and/or a drying phase are inserted.

The different displacements are controlled easily in very precise manner thanks to the step motor.

When the cycle is complete, the cover is removed and the colored slides are retrieved for examination.

Single use casing 40 is removed and replaced by a new casing. The device is again ready for use without any trace of reactant or other pollution coming from the preceding slides.

The device according to the invention allows working with new micro baths, without pollution, with very small volumes of reactant, and is therefore economical. Several slides L can be processed simultaneously, which improves the yield of single micro bath devices for processing single slides.

The work is performed partially in masked time and can be automated in simple manner and is programmable, such as the coloration time or the transfer time from chamber C1 to C2, which makes the operation even faster.

To be noted that the reactant volume is self-regulated as indicated above but also that the soaking level of the slides is determined by the height of relief 30 which corresponds exactly to the examination zone without contaminating the zone of sintered or polished glass which receives the identification information of each slide.

There are also situations in which, in function of the reactants and associated protocols, the coloration time is very short.

In this case, it is possible to add discharge cannulae such as cannula 68, but arranged this time one on the right of each hole 54 leading to a cavity A1 . . . A8 of chamber C1 in order to quickly aspirate the major portion of reactant from each cavity, the remainder is evacuated by centrifugation immediately after retraction of the subject discharge cannula.

Because of this, the soaking in bath is interrupted rapidly at least for the zone to be examined. Nevertheless, even if a cannula cannot retrieve completely this reactant, according to the present invention, the centrifugation will eliminate the reactant almost completely, preventing the pollution of the following reactant by the preceding reactant.

To be noted also that the device according to the present invention prevents blockage of tubes or cannulae because the cannulae have a sufficiently large diameter.

Similarly, since the reactants remain in liquid form, without pulverization, there is no contamination of the base or the environment.

Such a device is totally suitable to meet the demands of the market segment of small establishments or for instantaneous substitution in large installations.

Similarly, the exploitation cost is reduced since the casing can be produced at compatible prices and the volumes of reactants are reduced.

1. (canceled)

2. Device for coloring slides according to claim 11, wherein the casing has a conjugated profile to the profile of the enclosure interior part.

3. Device for coloring slides according to claim 11, wherein the enclosure interior part when the removable casing is received therein further comprises a first and a second concentric chamber, separated by a relief to enable transfer of liquid content in the first chamber to the second chamber under the influence of centrifugal force generated by the rotation of the enclosure by the motor.

4. Device for coloring slides according to claim 3, wherein the relief includes an interior slope with mild slope forming a wall of the first chamber and an exterior slope with steep slope forming a wall of the second chamber.

5. Device for coloring slides according to claim 4, wherein the second chamber includes a peripheral exterior wall with negative slope.

6. Device for coloring slides according to claim 5, wherein the casing includes cavities in the first chamber each provided with protruding ribs oriented radially in order to hold said slides in a position to limit surface contact with each slide.

7. Device for coloring slides according to claim 6, wherein the cover includes cavities to receive an end of each slide received in the interior part of the enclosure in order to ensure mechanical holding of each slide in the interior part of the enclosure.

8. Device for coloring slides according to claim 7, wherein the cover includes through holes suitable for inserting injection/removal cannulae therethrough.

9. Device for coloring slides according to claim 8, wherein the injection/removal cannulae include at least one cannula for injecting coloring reactant into the first chamber, and at least one aspiration cannula.

10. Device for coloring slides according to claim 11, wherein the removable casing is a single use casing, made from impervious material.

11. Device for coloring slides for microscopic examination comprising:
a base;
an enclosure forming an open interior part;
an openable cover for closing the interior part;
a motor mounted on the base and adapted to rotate the enclosure;
a removable casing received in the interior part;
wherein the enclosure interior part when the removable casing is received therein is adapted to receive and hold slides to be colored.

12. Device for coloring slides according to claim 3, wherein the casing includes a plurality of radially oriented cavities in the first chamber, and wherein slides received and held in the enclosure interior part are each received and held in a separate one of the plurality of cavities.

13. Device for coloring slides according to claim 12, wherein the cover includes through holes suitable for inserting injection/removal cannulae therethrough, and additionally includes at least one cannula for injecting coloring reactant into each separate one of the plurality of cavities in which a slide is positioned.

14. Device for coloring slides for microscopic examination comprising:
a base;
an enclosure forming an open interior part;
a openable cover for closing the interior part;
a motor mounted on the base and adapted to rotate the enclosure;
a removable casing received in the interior part;
a first chamber formed in the interior part when the removable casing is received therein, said first chamber being divided into a plurality of radial cavities each adapted to receive a portion of a slide therein;
a second chamber concentric with the first chamber formed in the interior part when the removable casing is received therein;
an annular relief separating the first and second chambers and providing a passage over the relief between the first and second chambers to thereby enable transfer of liquid from the radial cavities of the first chamber to the second chamber over the relief under the influence of centrifugal force generated by the rotation of the enclosure by the motor; and
means for supplying reactant to selected radial cavities of the first chamber.

15. Device for coloring slides for microscopic examination according to claim 14, wherein the means for supplying reactant to selected radial cavities of the first chamber includes through holes in the cover alignable with the radial cavities of the first chamber.

16. Device for coloring slides for microscopic examination according to claim 15, wherein the means for supplying reactant to selected radial cavities of the first chamber additionally includes cannulae insertable through selected through holes in the cover to inject reactant into the selected radial cavities of the first chamber.

17. Device for coloring slides for microscopic examination according to claim 16, wherein reactant supplied to the selected radial cavities of the first chamber are transferred from the radial cavities of the first chamber to the second chamber over the relief under the influence of centrifugal force generated by the rotation of the enclosure by the motor.

18. Device for coloring slides for microscopic examination according to claim 14, wherein the radial cavities of the first chamber have an accumulated volume, and wherein the second chamber has a volume which is greater that the accumulated volume of the radial cavities of the first chamber.

19. Device for coloring slides for microscopic examination according to claim 14, wherein the removable casing may be removed from the interior part after each use and replaced.
